(19) United States
(12) Patent Application Publication
(10) Pub. No.: US 2024/0400367 A1
(43) Pub. Date: Dec. 5, 2024

(54) SYSTEM AND METHOD OF INTRODUCING ALCOHOL INTO A CONTINUOUS BEVERAGE STREAM

(71) Applicant: Bevcorp, LLC, Eastlake, OH (US)

(72) Inventor: Lawrence Michael Lucas, Copper Hill, VA (US)

(73) Assignee: Bevcorp, LLC, Eastlake, OH (US)

(21) Appl. No.: 18/326,425

(22) Filed: May 31, 2023

(51) Int. Cl. B67D 1/12; G01F 1/84

(52) U.S. Cl. CPC B67D 1/1295; B67D 1/1204; G01F 1/84

(57) ABSTRACT

A method for determining required volumetric mass flow of alcoholic blended beverage ingredients for a continuous blend system using a computing device includes receiving a required syrup/water ratio, a selected target alcohol strength, an alcohol strength of an alcohol supply, a type of container, and a selected container filling rate; calculating a required volumetric mass flow of ingredients, a required alcohol volumetric mass flow of the alcohol supply, a required blended syrup and water volumetric mass flow of a proportioner, and a required syrup volumetric mass flow of a syrup supply to the proportioner for the production fill; calculating a volumetric mass flow of water in the required alcohol volumetric mass flow of the alcohol supply and a required water volumetric mass flow of a water supply to the proportioner for the production fill accounting for the calculated volumetric mass flow of; and, outputting instructions to the continuous blend system.

### BACKGROUND

Beverages are typically packaged into cans, bottles (glass or plastic) and other containers using high speed blending and filling systems. Containers are conveyed to a filling machine where the product blend is dispensed into individual containers that are then sealed (e.g., a lid or cap is joined to the filled container). Carbonated beverages such as soft drinks further include a carbonation step between the blending and filling stages, wherein CO₂ is dissolved into the beverage. These processes are usually performed at high speeds, requiring precise control of various parameters such that even a small deviation in one process condition can reduce throughput or result in deleterious effects on the process and/or the packaged beverage.

Improved high speed blending and filling systems and methods are described herein.

### SUMMARY

In some aspects, the techniques described herein relate to a computer-implemented method for determining required volumetric mass flow of alcoholic blended beverage ingredients for a continuous blend system associated with a high-speed filling machine, including: receiving, with a computing device, input regarding a production fill of an alcoholic blended beverage for a high-speed filling machine including a selected alcoholic blended beverage having a required syrup/water ratio, a selected target alcohol strength (“% ABV Target”), an alcohol strength of an alcohol supply (“% ABV Supply”), a type of container, and a selected container filling rate; calculating, with a computing system, a required volumetric mass flow of alcoholic blended beverage ingredients for the production fill; calculating, with a computing system, a required alcohol volumetric mass flow of the alcohol supply for the production fill; calculating, with a computing system, a required blended syrup and water volumetric mass flow of a proportioner for the production fill; calculating, with a computing system, a required syrup volumetric mass flow of a syrup supply to the proportioner for the production fill; calculating, with a computing system, a volumetric mass flow of water in the required alcohol volumetric mass flow of the alcohol supply; calculating, with a computing system, a required water volumetric mass flow of a water supply to the proportioner for the production fill accounting for the calculated volumetric mass flow of water in the required alcohol volumetric mass flow of the alcohol supply; and outputting instructions, with a computing system, to a continuous blend system associated with the high-speed filling machine for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow into the continuous blend system for supply of the alcoholic blended beverage to the high-speed filling machine.

In some aspects, the techniques described herein relate to a non-transitory computer-readable storage medium having instructions stored thereon that, in response to execution by one or more processors of a computing system, cause the computing system to perform actions including: receiving input regarding a production fill of an alcoholic blended beverage for a high-speed filling machine including a selected alcoholic blended beverage having a required syrup/water ratio, a selected target alcohol strength (“% ABV Target”), an alcohol strength of an alcohol supply (“% ABV Supply”), a type of container, and a selected container filling rate; calculating a required volumetric mass flow of alcoholic blended beverage ingredients for the production fill; calculating, with a computing system, a required alcohol volumetric mass flow of the alcohol supply for the production fill; calculating, with a computing system, a required blended syrup and water volumetric mass flow of a proportioner for the production fill; calculating, with a computing system, a required syrup volumetric mass flow of a syrup supply to the proportioner for the production fill; calculating, with a computing system, a volumetric mass flow of water in the required alcohol volumetric mass flow of the alcohol supply; calculating, with a computing system, a required water volumetric mass flow of a water supply to the proportioner for the production fill accounting for the calculated volumetric mass flow of water in the required alcohol volumetric mass flow of the alcohol supply; and outputting instructions to a continuous blend system associated with the high-speed filling machine for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow into the continuous blend system for supply of the alcoholic blended beverage to the high-speed filling machine.

In some aspects, the techniques described herein relate to a continuous blend system for a high-speed filler configured to continuously blend alcohol, water, and syrup to produce an alcoholic blended beverage having a having a selected syrup/water ratio and a selected target alcohol strength (“% ABV Target”), the continuous blend system including: a mass flow based multi-stream blending assembly, including: an alcohol supply for supplying a required volumetric mass flow of alcohol having an alcohol supply strength (“% ABV Supply”); a proportioner for supplying a required volumetric mass flow of blended syrup and water; a water supply in selective fluid communication with the proportioner for supplying a required volumetric mass flow of water to the proportioner; a syrup supply in selective fluid communication with the proportioner for supplying a required volumetric mass flow of syrup to the proportioner; and a computing system having non-transitory computer-readable storage medium with instructions stored thereon that, in response to execution by one or more processors of the computing system, cause the computing system to perform actions including: receiving input regarding a production fill of an alcoholic blended beverage for a high-speed filling machine including a selected alcoholic blended beverage having a required syrup/water ratio, a selected target alcohol strength (“% ABV Target”), the alcohol supply strength (“% ABV Supply”), a type of container, and a selected container filling rate; calculating a required volumetric mass flow of alcoholic blended beverage ingredients for the production fill; calculating a required alcohol volumetric mass flow of the alcohol supply for the production fill; calculating a required blended syrup and water volumetric mass flow of a proportioner for the production fill; calculating a required syrup volumetric mass flow of a syrup supply to the proportioner for the production fill; calculating a volumetric mass flow of water in the required alcohol volumetric mass flow of the alcohol supply; calculating a required water volumetric mass flow of a water supply to the proportioner for the production fill accounting for the calculated volumetric mass flow of water in the required alcohol volumetric mass flow of the alcohol supply; and outputting instructions for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow to the tank for supply of the alcoholic blended beverage to a high-speed filling machine.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a schematic illustration of a non-limiting example of a system for producing ready-to-drink alcoholic blended beverages for subsequent filling according to various aspects of the present disclosure.

FIG. 2 is a block diagram that illustrates aspects of a non-limiting example of a computing system configured to carry out some or all of the functions of the system for producing ready-to-drink alcoholic blended beverages for subsequent filling according to various aspects of the present disclosure.

FIG. 3 is a flowchart that illustrates a non-limiting example of a method of determining required volumetric mass flow for alcoholic blended beverage ingredients for a continuous blend system associated with a high-speed filling machine.

FIG. 4 is a block diagram that illustrates a non-limiting example of a computing device appropriate for use as a computing device with systems and methods of the present disclosure.

### DETAILED DESCRIPTION

Premixed, ready-to-drink, individual servings of alcoholic blended beverages are becoming increasingly popular. Alcohol is mixed with various liquid product blends, such as a mixture of syrup and water, or a premanufactured product (e.g., a lemonade or tea product, such as Arizona™ tea) to create pre-mixed alcoholic beverages of various recipes (e.g., hard seltzers, cocktails, etc.). If appropriate for the particular alcoholic beverage being produced, the product blend is carbonated prior to filling containers.

Such premixed, ready-to-drink alcoholic blended beverages can be produced using the high-speed filling machines discussed above; however, the typical process used is very cumbersome and inefficient. For instance, the alcohol is mixed with syrup, water, and any other ingredients in a large tank, and then the batched alcohol/syrup/water blend (“alcoholic liquid product blend”) is supplied to the filling machine for deaeration, carbonation, filling, etc. In another instance, the alcohol is mixed with a premanufactured product in a large tank and then supplied to filling machine. The batching tank must therefore be sufficiently large to fill a desired number of containers in a production fill (e.g., 1000 to 2000 containers). Moreover, the batch process must be done for each recipe, even if the recipe uses the same or similar ingredients in different amounts.

By comparison, for a typical nonalcoholic ready to drink beverage, the liquid product blend ingredients are continuously introduced into the supply line of the high-speed filling machine in individual, controlled amounts. For instance, the supply of both water and syrup for the liquid product blend may be monitored and controlled using mass flow meters and controllable valves. Adjustment of the blend ratio may be made by comparing the calculated ratio to set beverage values. In this manner, the beverage recipe can be precisely controlled.

Improved systems and methods for making a ready to drink, premixed alcoholic blended beverage using a continuous blend system for a high-speed filling machine are disclosed herein.

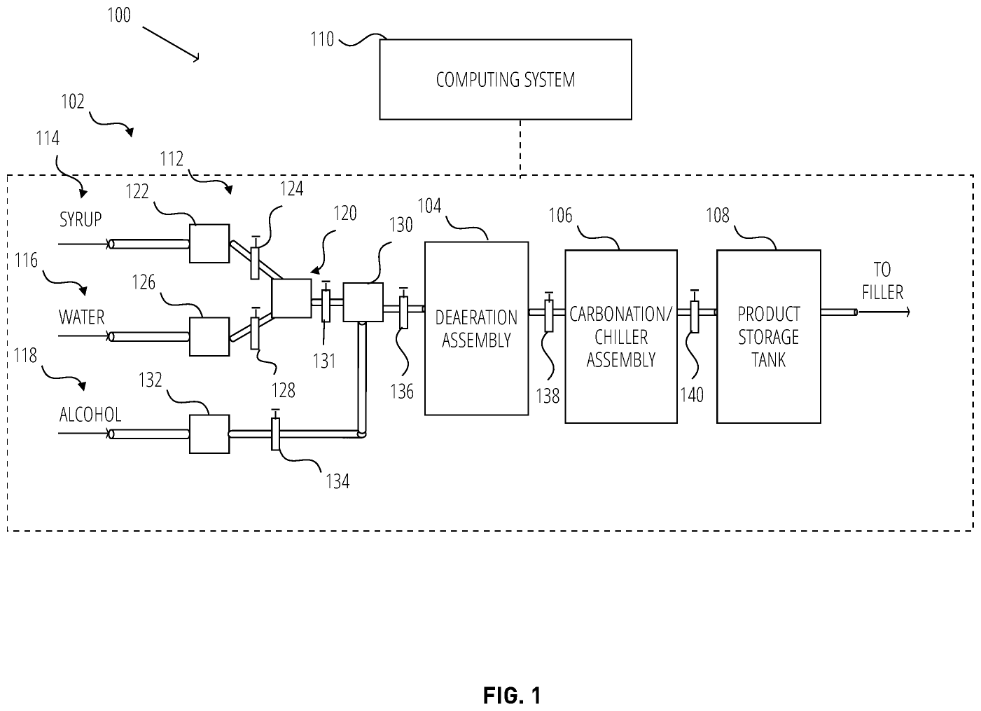

FIG. 1 is a schematic illustration of one example of a system 100 for producing ready-to-drink alcoholic blended beverages for subsequent filling. The system 100 generally includes a mass flow based multi-stream continuous blend system 102 configured to measure, control, and blend various beverage ingredients for supply to a filler (such as an electronic volumetric filler, a mechanical rotary filler, an aseptic filler, etc.) The continuous blend system 102 may include a deaeration assembly 104 generally configured to deaerate the alcoholic liquid product blend, a carbonation/chiller assembly 106 generally configured to add carbonation to the alcoholic liquid product blend, and a product storage tank 108 sized for interim storage of a suitable volume of alcoholic liquid product blend for supply to the filler. A computing system 110 is in communication with the continuous blend system 102 for controlling and monitoring the various components of the blending system.

By way of example, the system 100 and/or the continuous blend system 102 may include the components and methods shown and described, for example, in U.S. Pat. Nos. 5,068,116, 5,314,703, 5,537,914, 5,552,171, 5,656,313, and 10,674,749 (all of which are incorporated by reference herein). Such methods and systems, available commercially from Bevcorp LLC as its Micro-Blend™ System or its Micro2™ System, provide precision blending of two or more streams to an accuracy of about +/−0.2% of target with repeatability of about +/−0.001. Coriolis mass flow meters may be used to gather mass flow data, and the computing system 110 may be used to calculate volumetric mass flows based on the absolute density of the syrup and temperature of the process water. Gas flow rates (CO₂ or N₂) for deaeration can be calculated and controlled using Coriolis mass flow meters to provide accuracies of within about 1%.

The continuous blend system 102 includes a mass flow based multi-stream blending assembly 112 supporting at least a syrup supply 114, a water supply 116, and an alcohol supply 118. Other supply lines for other ingredients may also be included. In general, the continuous blend system 102 is configured to blend a continuous supply of syrup and alcohol with process water according to product specifications to provide a continuous alcoholic liquid product blend supply to the other assemblies of the continuous blend system 102 and/or the filler.

As used herein, the term “syrup” may include any concentrated flavoring composition that is combined with water to form a potable beverage. Syrups, particularly those used in the production of soft drinks, are typically of a higher viscosity than water. Syrups generally include a small amount of water to facilitate manufacture of the syrup, as well as blending (e.g., so the syrup can be metered and delivered to a blending stage for blending with process water). Syrups are typically mixtures of several ingredients, including one or more flavoring components, sweeteners (e.g., sugar) and other functional additives. In other instances, the syrup for a particular beverage includes only a flavoring component(s) and water.

The ratio of syrup and water used to create a liquid product blend may be at least partially dependent on whether the blended beverage is a regular beverage (sugar-based syrup) or a diet beverage (sugar-free syrup). For a diet blended beverage, the ratio of diet syrup and water is typically fixed for the recipe (such as five (5.0), or five percent (5%) diet syrup and ninety-five percent (95%) water) because the flow meters of a blending machine that can measure sugar content of a syrup cannot measure acid content by density. For a regular blended beverage, the ratio of regular (sugar-based) syrup and water may vary based on the strength or sugar content of the syrup, either as measured by flow meters of the blending machine or from known values of the syrup. For instance, for a stronger syrup (e.g., high sugar content), the syrup to water ratio may be lower compared to the syrup to water ratio used for a diet beverage (e.g., four and a half (4.5), or four and a half percent (4.5%) regular syrup and ninety-five percent (95.5%) water). Comparatively, for a weaker syrup (e.g., lower sugar content), the syrup to water ratio may be lower compared to the syrup to water ratio used for a diet beverage (four and a half (4.5), or four and a half percent (4.5%) regular syrup and ninety-five percent (95.5%) water). Exemplary methods for calculating volumetric mass flow of syrup and water for a selected beverage recipe are described in U.S. Pat. Nos. 5,068,116, 5,314,703, 5,537,914, 5,552,171, and 5,656,313 (all of which are incorporated by reference herein).

As used herein, the term “alcohol” may include any type of alcohol found in drinks such as beer, wine, and liquor that is produced by fermentation of grains, fruits, or other sources of sugar. The alcohol supply 118 may simply include ethanol, a liquor (e.g., rum, gin, vodka, whiskey, tequila, brandy, etc.), a liqueur (amaretto, bitters, etc.), and/or distilled spirits or fermented alcohol (such as beer or wine). If ethanol is used, the alcohol supply 118 may be pure ethanol, or in many instances, a combination of ethanol and water is used. For instance, a mixture of ethanol and water that is usually less than twenty percent ethanol (20% ABV (Alcohol by volume)) may be supplied to the filler to comply with NEC Class1 Div1 electrical design requirements. If other electrical design requirements or standards require a lower ABV (e.g., IEC), the supply of ethanol may be diluted with water such that the percentage of ethanol in the alcohol supply 118 is less than the required ABV. If it is desired to use a supply of alcohol greater than 20% ABV (or another threshold level per other standards), the filler may be augmented to be explosion proof, as required many electrical codes.

Syrup and water may flow into a proportioner 120 of the continuous blend system 102 that is generally configured to receive and mix proportioned amounts of syrup and water. For instance, the proportioner 120 may be similar to the proportioner shown and described in U.S. Pat. No. 5,656,313 (incorporated herein). The syrup supply 114 is in fluid communication with a syrup mass flow meter 122, and the flow of syrup to the proportioner 120 is controlled by a syrup flow control valve 124 based on the product recipe and control signals received from the computing system 110. Similarly, the water supply 116 is in fluid communication with a water mass flow meter 126 and the flow of process water to the proportioner 120 is controlled by a water flow control valve 128 based on the product recipe and control signals received from the computing system 110.

The syrup and water may be blended together in the proportioner 120 and then combined with alcohol at a mixing tank 130. The flow of blended syrup and water may be controlled by a blended syrup/water flow control valve 131 based on the product recipe and control signals received from the computing system 110. The alcohol supply 118 is in fluid communication with an alcohol mass flow meter 132 and the flow of alcohol to the mixing tank 130 is controlled by an alcohol flow control valve 134 based on the product recipe and control signals received from the computing system 110. It should be appreciated that the syrup, water, and alcohol may instead be mixed together in a proportioner or a similar assembly rather than adding alcohol to a liquid blend of syrup and water. Liquid mass flow of syrup, water, and alcohol can be controlled using variable frequency drives (or VFD's) to control liquid pumps (not shown).

As noted above, the continuous blend system 102 may also include a deaeration assembly 104 configured to deaearate the alcoholic liquid product blend. The deaeration assembly 104 may be substantially similar to the deaeration assembly shown and described in U.S. Pat. No. 10,674,749 (incorporated herein). The process water may be deaearated in the conventional manner prior to blending with the syrup, particularly if the level of dissolved O₂ in the process water is high (e.g., above 2 to 3 ppm O₂). Deaeration of the process water prior to blending with the syrup may be also desirable when N2 is used for deaeration of the alcoholic liquid product blend in the deaeration assembly 104 in order to reduce foaming. Flow from the mixing tank 130 to the deaeration assembly 104 may be controlled through a deaeration assembly control valve 136.

After deaeration, the alcoholic liquid product blend may flow to a carbonation/chiller assembly 106 for adding any necessary carbonation (C0₂) to the blend. Flow from the deaeration assembly 104 to the chiller assembly 106 may be controlled through a carbonation/chiller assembly control valve 138. After carbonation, the alcoholic liquid product blend may flow towards the product storage tank 108 (controlled by storage tank control valve 140) and thereafter to a filler or bottling apparatus (not shown).

Although not shown in FIG. 1, the system 100 may further include various other conventional components used in beverage blending and carbonation systems, particularly meter-based control features that control blending and carbonation based on mass flow metering and the like. Thus, the system 100 may include, for example, various sensors and other devices for communication with the computing system 110, various actuators that are activatable in response to instructions received from the computing system 110, and other devices configured to control aspects of blending in accordance with stored instructions and acquired data. For instance, the system 100 may include a downstream beverage analyzer configured to determine the actual proportion of syrup, water, and alcohol within the blended beverage, such as the analyzer shown and described in U.S. Pat. No. 5,656,313 (incorporated herein). In that regard, the computing system 110 may output instructions to the various valves to adjust the proportion of ingredients based on the output data of the analyzer.

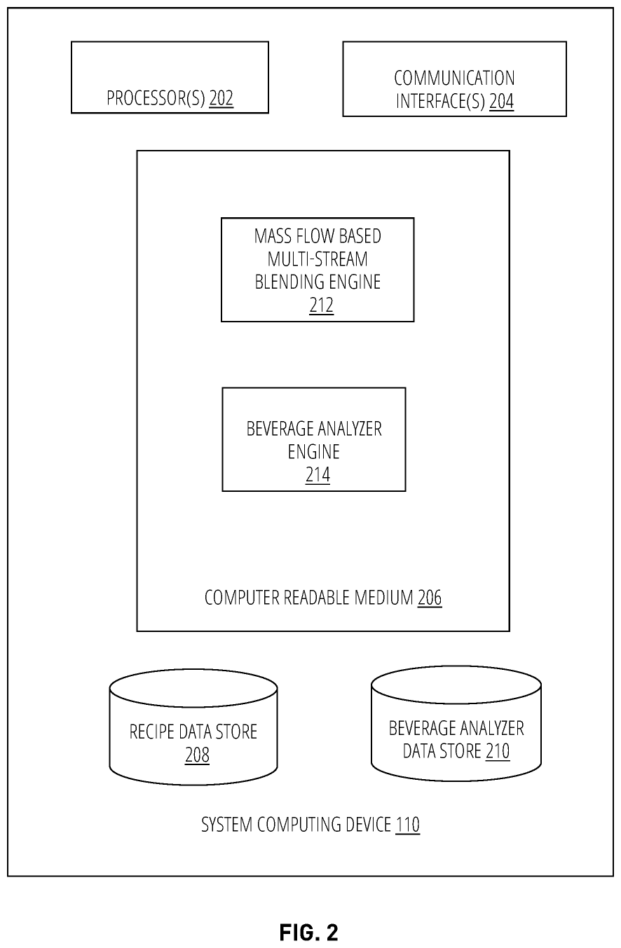

FIG. 2 depicts a block diagram that illustrates aspects of a non-limiting example of the computing system 110 configured to carry out some or all of the functions of the system 100 described herein. As discussed herein, the computing system 110 is generally configured to store and retrieve product specification data (i.e., product recipes), as well as receiving signals from various sensors and other devices and controlling various actuators and other devices in accordance with stored instructions and acquired data. In the depicted example, the computing system 110 includes a processor(s) 202, a communication interface(s) 204, and computer readable medium 206, and one or more data stores (e.g., a recipe data store 208 and a beverage analyzer data store 210).

The computing system 110 may be implemented by any computing device or collection of computing devices, including but not limited to a programmable logic controller (PLC), a desktop computing device, a laptop computing device, a mobile computing device, a server computing device, a computing device of a cloud computing system, and/or combinations thereof. In some examples, the processor(s) 202 may include any suitable type of general-purpose computer processor. In some examples, the processor(s) 202 may include one or more special-purpose computer processors or AI accelerators optimized for specific computing tasks, including but not limited to graphical processing units (GPUs), vision processing units (VPTs), and tensor processing units (TPUs).

In some examples, the communication interface(s) 204 include one or more hardware and or software interfaces suitable for providing communication links between components. The communication interface(s) 204 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer readable medium 206 has stored thereon logic that, in response to execution by the one or more processor(s) 202, may cause the computing system 110 to provide a mass flow based multi-stream blending engine 212 and a beverage analyzer engine 214.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The mass flow based multi-stream blending engine 212 of the computing system 110 is configured to receive input signals received from system sensors (such as the mass flow meters, float sensors, etc.), automated instructions and/or user input received via a human machine interface (HMI) of the computing system 110 or a computing device in communication with the computing system 110, or input signals received from other devices of the continuous blend system 102 or devices associated therewith. The mass flow based multi-stream blending engine 212 processes the system input signals and outputs one or more signals for activating actuators in communication with the system valves. For instance, the syrup flow control valve 124, the water flow control valve 128, the syrup/water blend valve, the blended syrup/water flow control valve 131, and the alcohol flow control valve 134 are selectively opened to enable the flow of the various liquid streams into the mixing tank 130 of the continuous blend system 102 for supplying an alcoholic liquid product blend to the filler according to product recipe and specifications (which may be stored in and retrieved from the recipe data store 208).

In that regard, the mass flow based multi-stream blending engine 212 may run a flow control module configured to determine the required volumetric mass flow for each ingredient of the alcoholic liquid product blend (e.g., syrup, water, and alcohol) for a specific product recipe. For instance, if a blended beverage recipe has specification requirements of five percent ABV (5% ABV) for a particular syrup/water ratio (e.g., Coca Cola®), the flow control module can determine the required mass flow for the syrup, water, and alcohol to create a blended beverage having the required specifications. After the flow control module determines the required volumetric mass flow for each ingredient of the recipe, the mass flow based multi-stream blending engine 212 outputs signals for activating actuators in communication with the system valves such that the appropriate flow of each ingredient is introduced into the continuous blend system 102.

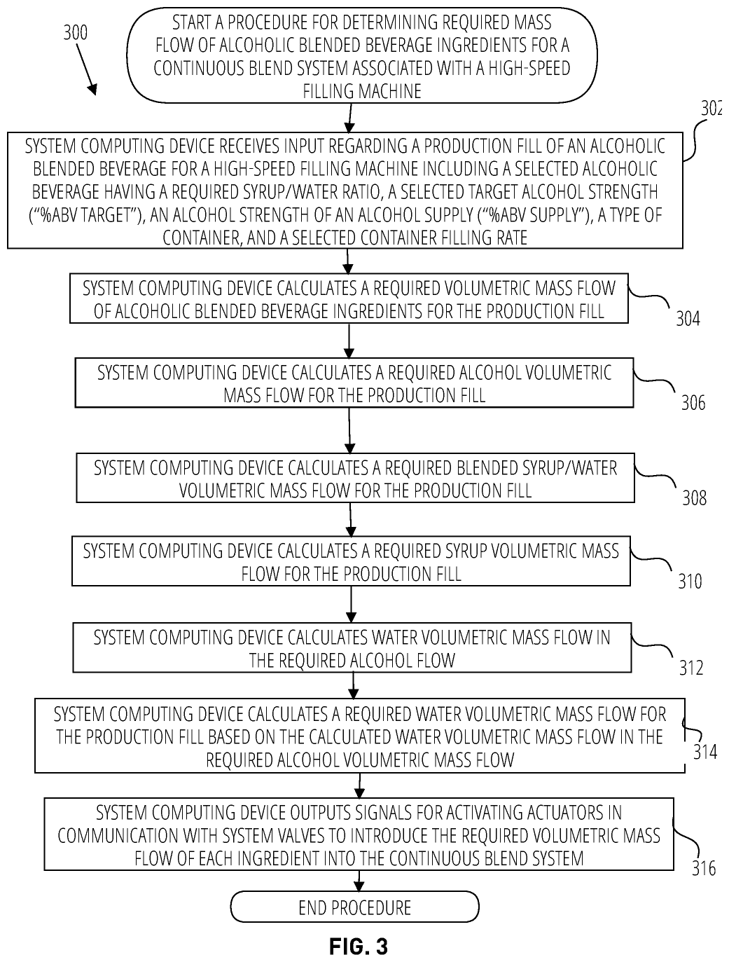

An exemplary method 300 of determining required volumetric mass flow (sometimes called the “required flow” or the “set point”) for alcoholic blended beverage ingredients for a continuous blend system associated with a high-speed filling machine will now be described with respect to FIG. 3. The exemplary method 300 may be used to determine the required volumetric mass flow for syrup, water, and alcohol (and any other ingredient) to create an alcoholic blended beverage having required specifications of a recipe.

For ease of description, the exemplary method 300 will be described as being carried out by the computing system 110, such as by the flow control module of the mass flow based multi-stream blending engine 212. However, it should be appreciated that the exemplary method 300 may instead be carried out by any other component of the computing system 110 or a computing device in communication with the blending system. Further, the exemplary method 300 may be carried out using the continuous blend system 102 described herein or another suitable blending system. In that regard, reference will be made to components of the continuous blend system 102 for illustrating aspects of the exemplary method 300.

From a start block, the method 300 proceeds to block 302, where the processor(s) 202 of the computing system 110 receives input regarding the production fill, including the selected alcoholic blended beverage to be filled, the type of containers, and the selected filling rate. Regarding the containers and filling rate, a user or operator associated with the continuous blend system 102 may manually designate the type/size of the container (e.g., 10 oz can/bottle, 12 oz can/bottle, 16 oz can/bottle, etc.) and the filling rate (cans per minute or CPM), or the blending machine may be pre-set to run a fixed size/type/rate.

Regarding the selected alcoholic blended beverage, the type of alcohol and the target % ABV of the finished alcoholic blended beverage as well as the type of syrup and the syrup/water ratio for the of the finished alcoholic blended beverage may be manually designated by an operator. Instead, an operator may select a recipe (e.g., a particular combination of alcohol and syrup and the corresponding % ABV and syrup/water ratio) from a database of recipes stored in the recipe data store 208. As yet another alternative, the recipe may be selected automatically based on the production fill day, time, or other factors.

The processor(s) 202 of the computing system 110 also receives input regarding the strength (% ABV) of the alcohol supply. More specifically, an input regarding the percentage of alcohol mixed with water, or the % ABV is provided, which may be inputted manually by an operator, or instead automatically if the alcohol supply remains constant over a period of time and/or is known for a certain production fill day, time, or other factors.

The processor(s) 202 of the computing system 110 may receive the inputs from an operator interfacing with an HMI associated with the computing system 110 or another computing device in communication therewith. Moreover, as noted above, one or more of the inputs may be generated automatically based on the production fill day, time, product recipe, or other factors.

The exemplary method 300 may proceed to block 304, where the computing system 110 may calculate a required volumetric mass flow (e.g., gallons per minute) of alcoholic blended beverage ingredients for the production fill. The required volumetric mass flow of alcoholic blended beverage ingredients for the production fill is the required volumetric mass flow of alcoholic blended beverage ingredients for supply to the filler for filling the required number of containers (e.g., the alcoholic liquid product blend supplied to the product storage tank 108) at the desired filling rate. Knowing that 128 ounces of fluid are in a gallon, the following equation may be used to calculate the required volumetric mass flow of alcoholic blended beverage ingredients, where “CPM” is containers per minute:

REQUIRED VOLUMETRIC MASS FLOW OF ALCOHOLIC BLENDED BEVERAGE INGREDIENTS=(CPM*(CONTAINER OUNCES SIZE))/128

For instance, the operator may want to fill twelve ounce (12 oz) cans at one thousand and sixty-six cans per minute (1066 CPM). The required volumetric mass flow of alcoholic blended beverage ingredients in the system needed to fill 1066 CPM (or more precisely, 1066.660 CPM) would be 100 GPM (Required Volumetric Mass Flow of Alcoholic Blended Beverage Ingredients=(1066*12)/128).

The exemplary method 300 may then proceed to block 306, where the computing system 110 may determine the required alcohol volumetric mass flow (e.g., gallons per minute) from the alcohol supply 118 for the production fill. For instance, the required alcohol volumetric mass flow is the flow of alcohol in gallons per minute from the alcohol supply 118 to the mixing tank 130 for the production fill. The following equation may be used to calculate the required alcohol volumetric mass flow, where “% ABV Supply” is the strength (% ABV) of the alcohol supply and “% ABV Target” is the strength (% ABV) of the finished alcoholic blended beverage:

REQUIRED ALCOHOL VOLUMETRIC MASS FLOW=(REQUIRED VOLUMETRIC MASS FLOW OF ALCOHOLIC BLENDED BEVERAGE INGREDIENTS/% ABV SUPPLY)*%ABV TARGET)

Continuing from the example discussed above, if the required volumetric mass flow is 100 GPM (the flow required to fill 1066.660 12 ounce cans per minute), the strength (% ABV) of the alcohol supply is 19.50% ABV, and the target alcohol strength (% ABV) is 5.00% ABV, the required alcohol volumetric mass flow would be 25.741 GPM (Required Alcohol Volumetric Mass Flow=(100/19.50)*5.00). In other words, 25.741 GPM of alcohol would need to flow from the alcohol supply 118 to the mixing tank 130 for the production fill.

The exemplary method 300 may then proceed to block 308, where the computing system 110 may determine the required blended syrup and water (or simply “blended syrup/water”) volumetric mass flow (e.g., gallons per minute) of the blended syrup and water supply (e.g., the proportioner 120) for the production fill. For instance, the required blended syrup/water volumetric mass flow is the flow of blended syrup/water in gallons per minute from the proportioner 120 to the mixing tank 130 for the production fill. The following simple equation may be used to calculate the required blended syrup/water volumetric mass flow:

REQUIRED BLENDED SYRUP AND WATER VOLUMETRIC MASS FLOW=REQUIRED VOLUMETRIC MASS FLOW OF ALCOHOLIC BLENDED BEVERAGE INGREDIENTS−REQUIRED ALCOHOL VOLUMETRIC MASS FLOW

Continuing from the example discussed above, if the required volumetric mass flow is 100 GPM (the flow required to fill 1066.660 12 ounce cans per minute) and the required alcohol volumetric mass flow for a 5.00% ABV target with an alcohol supply is 19.50% ABV is 25.741 GPM, the required blended syrup/water volumetric mass flow is 74.359 GPM (Required Blended Syrup and Water Volumetric Mass Flow=100-25.741). In other words, 74.359 GPM of blended syrup/water would need to flow from the proportioner 120 to the mixing tank 130 for the production fill.

The exemplary method 300 may then proceed to blocks 310 and 314, where the computing system 110 may determine the required syrup volumetric mass flow (e.g., gallons per minute) and the required water volumetric mass flow (e.g., gallons per minute) for the production fill, respectively. For instance, the required syrup volumetric mass flow is the flow of syrup in gallons per minute from the syrup supply 114 to the proportioner 120 for the production fill, and the required water volumetric mass flow is the flow of water in gallons per minute from the water supply 116 to the proportioner 120 for the production fill.

The required syrup volumetric mass flow may be calculated according to the methods described in U.S. Pat. Nos. 5,068,116, 5,314,703, 5,537,914, 5,552,171, and 5,656,313 (all of which are incorporated by reference herein). Generally, the determination of the volumetric flow rate of a syrup as a function of the mass flow is also a function of its density. The density value for a sugared syrup may be calculated as a function of published brix values. Curves providing this information are published by the National Bureau of Standards at Table No. 113. Typically, the density of a sugar-free syrup can be estimated to be one, i.e. substantially the same as water at 20° C.

Simplifying the methods described in U.S. Pat. Nos. 5,068,116, 5,314,703, 5,537,914, 5,552,171, and 5,656,313, the following equation may be used to calculate the required syrup volumetric mass flow:

REQUIRED SYRUP VOLUMETRIC MASS FLOW=((REQUIRED BLENDED SYRUP AND WATER VOLUMETRIC MASS FLOW/(SYRUP/WATER RATIO)))+SYRUP DENSITY

Continuing from the example discussed above, if the required volumetric mass flow of alcoholic blended beverage ingredients for the production fill is 100 GPM (the flow of blended ingredients required to fill 1066.660 12 ounce cans per minute), the required blended syrup/water volumetric mass flow is 74.359 GPM, and the syrup/water ratio is 5.00, and assuming a density of 1 for the syrup, the required syrup volumetric mass flow is 15.872 GPM ((74.359/5.00)+1). In other words, 15.872 GPM of syrup would need to flow from the syrup supply 114 to the proportioner 120 for the production fill.

Other methods for calculating the required syrup volumetric mass flow may be used. For instance, known programmable logic controller (PLC) programs configured to calculate the required syrup volumetric mass flow for a continuous blend system may be used.

The required water volumetric mass flow for a non-alcoholic blended beverage is typically calculated by simply subtracting the required syrup volumetric mass flow from the required volumetric mass flow of alcoholic blended beverage ingredients. However, the required water volumetric mass flow for an alcoholic blended beverage is dependent on the amount of water in the alcohol supply 118. For example, less required water volumetric mass flow would be needed if water is present in the alcohol supply 118 to avoid diluting the alcoholic blended beverage.

In that regard, the volumetric mass flow of water in the alcohol supply 118 must first be calculated by the computing system 110 in step 312. The volumetric mass flow of water in the alcohol supply 118 may be calculated with the following equation:

VOLUMETRIC MASS FLOW OF WATER IN ALCOHOL SUPPLY=REQUIRED ALCOHOL VOLUMETRIC MASS FLOW*%WATER IN THE ALCOHOL SUPPLY

The water in the alcohol supply (GPM) and the required alcohol flow (or required alcohol volumetric mass flow) may be calculated as described above. The percentage (%) of water in the alcohol supply may be calculated using the % ABV of the alcohol supply 118 because the % ABV and the percentage (%) of water in the alcohol supply necessarily equal 100%. Thus, continuing from the example discussed above, if the % ABV Supply, or the strength (% ABV) of the alcohol supply 118 is 19.50% ABV, the percentage of water in the alcohol supply is 80.50% (100−% ABV Supply, or 100−19.50). Thus, the volumetric mass flow of water (GPM) in the alcohol supply 118 is 20.641 GPM (25.641*80.5%).

Knowing the volumetric mass flow of water (GPM) in the alcohol supply 118, the exemplary method 300 may then proceed to block 314, where the computing system 110 may determine the required water volumetric mass flow (e.g., gallons per minute) for the production fill. As noted above, the required water volumetric mass flow is the flow of water in gallons per minute (GPM) from the water supply 116 to the proportioner 120 for the production fill. In that regard, the required water volumetric mass flow may be determined by the difference between the required syrup/water volumetric mass flow and the volumetric mass flow of water in the alcohol supply. For instance, the required water volumetric mass flow may be calculated as follows:

REQUIRED WATER VOLUMETRIC MASS FLOW=(REQUIRED BLENDED SYRUP AND WATER VOLUMETRIC MASS FLOW-REQUIRED SYRUP VOLUMETRIC MASS FLOW)−VOLUMETRIC MASS FLOW OF WATER IN THE ALCOHOL SUPPLY

If the required syrup/water volumetric mass flow is 74.359 GPM, the required syrup volumetric mass flow is 15.872 GPM, and the volumetric mass flow of water in the alcohol supply is 20.641 GPM, then the required water volumetric mass flow needed for making the alcoholic blended beverage would be 37.846 GPM ((74.359 GPM−15.872 GPM)-20.641 GPM). In other words, 37.846 GPM of water would need to flow from the water supply 116 to the proportioner 120 for a production fill of a non-alcoholic blended beverage for 1066.660 12 ounce cans per minute, a syrup/water ratio of 5.00 (and assuming a density of 1 for the syrup), % ABV Supply of 19.50, and a % ABV Target of 5.00%.

After the exemplary method 300 is used to determine the required volumetric mass flow for each ingredient of the recipe, the exemplary method 300 may proceed to block 316, where computing system 110 outputs signals for activating actuators in communication with the system valves such that the required volumetric mass flow of each ingredient is introduced into the continuous blend system 102. The exemplary method 300 may then end and restart for a new production fill having different parameters for an alcoholic blended beverage.

The alcoholic blended beverage may be analyzed for accuracy with a downstream analyzer that takes samples from the flow into the filler. The samples are used to determine the accuracy of the blend as performed by the proportioner 14 and compare it to the fixed standards. The beverage analyzer engine 214 of the computing system 110 may analyze sample data, such as by referencing one or more beverage analysis files (e.g., fixed standards) stored in the beverage analyzer data store 210.

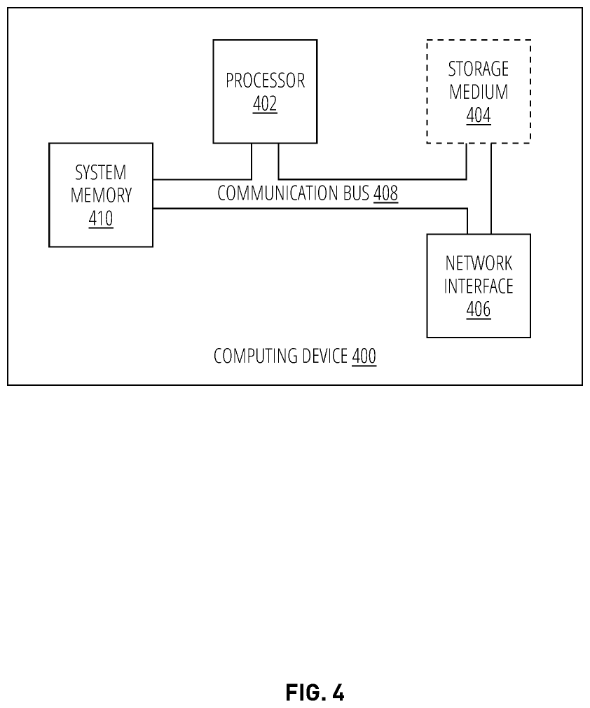

FIG. 4 is a block diagram that illustrates aspects of an exemplary computing device 400 appropriate for use as a computing device of the present disclosure. While multiple different types of computing devices were discussed above, the exemplary computing device 400 describes various elements that are common to many different types of computing devices. While FIG. 4 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 400 may be any one of any number of currently available or yet to be developed devices.

In its most basic configuration, the computing device 400 includes at least one processor 402 and a system memory 410 connected by a communication bus 408. Depending on the exact configuration and type of device, the system memory 410 may be volatile or nonvolatile memory, such as read only memory (“ROM”), random access memory (“RAM”), EEPROM, flash memory, or similar memory technology. Those of ordinary skill in the art and others will recognize that system memory 410 typically stores data and/or program modules that are immediately accessible to and/or currently being operated on by the processor 402. In this regard, the processor 402 may serve as a computational center of the computing device 400 by supporting the execution of instructions.

As further illustrated in FIG. 4, the computing device 400 may include a network interface 406 comprising one or more components for communicating with other devices over a network. Examples of the present disclosure may access basic services that utilize the network interface 406 to perform communications using common network protocols. The network interface 406 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 406 illustrated in FIG. 4 may represent one or more wireless interfaces or physical communication interfaces described and illustrated above with respect to particular components of the computing device 400.

In the exemplary example depicted in FIG. 4, the computing device 400 also includes a storage medium 404. However, services may be accessed using a computing device that does not include means for persisting data to a local storage medium. Therefore, the storage medium 404 depicted in FIG. 4 is represented with a dashed line to indicate that the storage medium 404 is optional. In any event, the storage medium 404 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 402, system memory 410, communication bus 408, storage medium 404, and network interface 406 are known and commercially available. For ease of illustration and because it is not important for an understanding of the claimed subject matter, FIG. 4 does not show some of the typical components of many computing devices. In this regard, the computing device 400 may include input devices, such as a keyboard, keypad, mouse, microphone, touch input device, touch screen, tablet, and/or the like. Such input devices may be coupled to the computing device 400 by wired or wireless connections including RF, infrared, serial, parallel, Bluetooth, Bluetooth low energy, USB, or other suitable connections protocols using wireless or physical connections. Similarly, the computing device 400 may also include output devices such as a display, speakers, printer, etc. Since these devices are well known in the art, they are not illustrated or described further herein.

In some instances, the systems and methods described herein may be configured for producing “single strength” ready-to-drink alcoholic blended beverages. A “single strength” ready-to-drink alcoholic blended beverage is a ready-to-drink beverage made from alcohol mixed with a premanufactured product. For instance, the “single strength” ready-to-drink alcoholic blended beverage may include a blend of alcohol and a premanufactured tea drink (e.g., Arizona™ tea).

A method for determining a required volumetric mass flow for “single strength” ready-to-drink alcoholic blended beverage ingredients for a continuous blend system associated with a high-speed filling machine may include determining the required volumetric mass flow of premanufactured beverage product and alcohol for a production fill. In that regard, the method may include selecting, for a known premanufactured product, a target alcohol strength (“% ABV Target”), a type of container, and a selected container filling rate. The alcohol strength of an alcohol supply (“% ABV Supply”) will be 100% ABV because if the alcohol was diluted with water, it would compromise the integrity (e.g., strength) of the premanufactured product.

The exemplary method may further include calculating, with a computing device, a required volumetric mass flow (e.g., gallons per minute) of alcoholic blended beverage ingredients for the production fill. The required volumetric mass flow of alcoholic blended beverage ingredients for the production fill is the required volumetric mass flow of alcoholic blended beverage ingredients for supply to the filler for filling the required number of containers at the desired filling rate. In that regard, the required volumetric mass flow of alcoholic blended beverage ingredients may be calculated using the equation set forth above:

$$REQUIRED VOLUMETRIC MASS FLOW OF ALCOHOLIC BLENDED BEVERAGE INGREDIENTS = ( CPM * ( CONTAINER OUNCES SIZE ) ) / 128$$

Thus, using an example similar to that provided above, the operator may want to fill twelve ounce (12 oz) cans at one thousand and sixty-six cans per minute (1066 CPM). The required volumetric mass flow of alcoholic blended beverage ingredients in the system needed to fill 1066 CPM (or more precisely, 1066.660 CPM) would be 100.00 GPM (Required Volumetric Mass Flow of Alcoholic Blended Beverage Ingredients=(1066*12)/128).

The method may then include calculating, with a computing system, a required alcohol volumetric mass flow of the alcohol supply for the production fill. For instance, the required alcohol volumetric mass flow is the flow of alcohol in gallons per minute from the alcohol supply to a mixing tank for the production fill. In that regard, the required alcohol volumetric mass flow may be calculated using the equation set forth above, where “% ABV Supply” is 100% ABV and “% ABV Target” is the strength (% ABV) of the finished alcoholic blended beverage:

REQUIRED ALCOHOL VOLUMETRIC MASS FLOW=(REQUIRED VOLUMETRIC MASS FLOW OF ALCOHOLIC BLENDED BEVERAGE INGREDIENTS/%ABV SUPPLY)*%ABV TARGET)

Continuing from the example discussed above, if the required volumetric mass flow is 100.00 GPM (the flow required to fill 1066.660 12 ounce cans per minute), the strength (% ABV) of the alcohol supply is 100% ABV, and the target alcohol strength (% ABV) is 5.00% ABV, the required alcohol volumetric mass flow would be 5.00 GPM (Required Alcohol Volumetric Mass Flow=(100/100)*5.00). In other words, 5.00 GPM of alcohol would need to flow from the alcohol supply to the mixing tank for the production fill.

The method may then include calculating, with a computing system, the required premanufactured product volumetric mass flow (e.g., gallons per minute) for the production fill. The following simple equation may be used to calculate the required premanufactured product volumetric mass flow:

REQUIRED PREMANUFACTURED PRODUCT VOLUMETRIC MASS FLOW=REQUIRED VOLUMETRIC MASS FLOW OF ALCOHOLIC BLENDED BEVERAGE INGREDIENTS−REQUIRED ALCOHOL VOLUMETRIC MASS FLOW

Continuing from the example discussed above, if the required volumetric mass flow is 100.00 GPM (the flow required to fill 1066.660 12 ounce cans per minute) and the required alcohol volumetric mass flow for a 5.00% ABV target with an alcohol supply of 100% ABV is 5.00 GPM, the required premanufactured product volumetric mass flow is 95.00 GPM (Required Premanufactured Product Volumetric Mass Flow=100.00-5.00). In other words, 95.00 GPM of premanufactured product would need to flow to a tank for mixing with the alcohol for the production fill.

After the exemplary method is used to determine the required volumetric mass flow for each ingredient of the “single strength” ready-to-drink alcoholic blended beverage recipe, the method may include outputting signals, with a computing system, for activating actuators in communication with the system valves such that the required volumetric mass flow of each ingredient is introduced into the continuous blend system. More specifically, the method may include outputting instructions, with a computing system, to a continuous blend system associated with the high-speed filling machine for activating actuators associated with valves of the of the alcohol supply and the premanufactured product supply to introduce the corresponding required alcohol volumetric mass flow and the required premanufactured product volumetric mass flow into the continuous blend system for supply of the alcoholic blended beverage to the high-speed filling machine. The “single strength” ready-to-drink alcoholic blended beverage may be analyzed for accuracy with a downstream analyzer that takes samples from the flow into the filler.

While the concepts of the present disclosure are susceptible to various modifications and alternative forms, specific examples thereof have been shown in the drawings and have been described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims. A person skilled in the relevant art will recognize that other components and configurations may be used without parting from the spirit and scope of the disclosure. Numerous specific details are described to provide a thorough understanding of the disclosure. However, in certain instances, well-known or conventional details are not described in order to avoid obscuring the description.

References in the specification to “one example.” “an example,” “an exemplary example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “upstream”, “downstream”, “left”, “right”, “first”, “second”, etc., in the present disclosure is meant to provide orientation for the reader with reference to the drawings and is not intended to be the required orientation of the components or graphical images or to impart orientation limitations into the claims.

Unless the context indicates otherwise, references herein to “bottling” and the like are intended to encompass not only the production of beverages packaged in bottles (glass or plastic), but also beverages packaged in metal cans and other types of containers-whether currently known or hereafter developed.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIG. Additionally, the inclusion of a structural or method feature in a particular FIG. is not meant to imply that such feature is required in all examples and, in some examples, it may not be included or may be combined with other features.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

For clarity of explanation, in some instances the present technology may be presented as including individual functional blocks representing devices, device components, steps or routines in a method embodied in software, or combinations of hardware and software.

Systems implementing methods according to this disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example. The instructions, media for conveying such instructions, computing resources for executing them, and other structures for supporting such computing resources are means for providing the functions described in these disclosures.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various examples given in this specification.

Titles or subtitles may be used in the examples for convenience of a reader, which in no way should limit the scope of the disclosure.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. As used herein, the terms “about”, “approximately.” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While illustrative examples have been illustrated and described, it will be appreciated that various changes can be made therein without departing from the spirit and scope of the invention.

1. A computer-implemented method for determining required volumetric mass flow of alcoholic blended beverage ingredients for a continuous blend system associated with a high-speed filling machine, comprising:
receiving, with a computing device, input regarding a production fill of an alcoholic blended beverage for a high-speed filling machine including a selected alcoholic blended beverage having a required syrup/water ratio, a selected target alcohol strength (“% ABV Target”), an alcohol strength of an alcohol supply (“% ABV Supply”), a type of container, and a selected container filling rate;
calculating, with a computing system, a required volumetric mass flow of alcoholic blended beverage ingredients for the production fill;
calculating, with a computing system, a required alcohol volumetric mass flow of the alcohol supply for the production fill;
calculating, with a computing system, a required blended syrup and water volumetric mass flow of a proportioner for the production fill;
calculating, with a computing system, a required syrup volumetric mass flow of a syrup supply to the proportioner for the production fill;
calculating, with a computing system, a volumetric mass flow of water in the required alcohol volumetric mass flow of the alcohol supply;
calculating, with a computing system, a required water volumetric mass flow of a water supply to the proportioner for the production fill accounting for the calculated volumetric mass flow of water in the required alcohol volumetric mass flow of the alcohol supply; and
outputting instructions, with a computing system, to a continuous blend system associated with the high-speed filling machine for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow into the continuous blend system for supply of the alcoholic blended beverage to the high-speed filling machine.

2. The computer-implemented method of claim 1, wherein the required volumetric mass flow of alcoholic blended beverage ingredients for the production fill is the required volumetric mass flow of alcoholic blended beverage ingredients for supply to the high-speed filling machine for filling a required number of the selected type of containers for the selected container filling rate.

3. The computer-implemented method of claim 1, wherein the required alcohol volumetric mass flow for the production fill is calculated by the following equation:
REQUIRED ALCOHOL VOLUMETRIC MASS FLOW=(REQUIRED VOLUMETRIC MASS FLOW OF ALCOHOLIC BLENDED BEVERAGE INGREDIENTS/%ABV SUPPLY)*%ABV TARGET).

4. The computer-implemented method of claim 1, wherein the required blended syrup and water volumetric mass flow for the production fill is calculated with the following equation:
REQUIRED BLENDED SYRUP AND WATER VOLUMETRIC MASS FLOW=REQUIRED VOLUMETRIC MASS FLOW OF ALCOHOLIC BLENDED BEVERAGE INGREDIENTS−REQUIRED ALCOHOL VOLUMETRIC MASS FLOW.

5. The computer-implemented method of claim 1, wherein the required syrup volumetric mass flow is calculated with the following equation:
REQUIRED SYRUP VOLUMETRIC MASS FLOW=((REQUIRED BLENDED SYRUP AND WATER VOLUMETRIC MASS FLOW/(SYRUP/WATER RATIO)))+SYRUP DENSITY.

6. The computer-implemented method of claim 1, wherein the volumetric mass flow of water in the alcohol supply is calculated with the following equation:
VOLUMETRIC MASS FLOW OF WATER IN ALCOHOL SUPPLY=REQUIRED ALCOHOL VOLUMETRIC MASS FLOW*%WATER IN THE ALCOHOL SUPPLY.

7. The computer-implemented method of claim 6, wherein the % of water in the alcohol supply is the % ABV Supply subtracted from 100.

8. The computer-implemented method of claim 1, wherein the required water volumetric mass flow is calculated with the following equation:
REQUIRED WATER VOLUMETRIC MASS FLOW=(REQUIRED BLENDED SYRUP AND WATER VOLUMETRIC MASS FLOW−REQUIRED SYRUP VOLUMETRIC MASS FLOW)−VOLUMETRIC MASS FLOW OF WATER IN THE ALCOHOL SUPPLY.

9. A non-transitory computer-readable storage medium having instructions stored thereon that, in response to execution by one or more processors of a computing system, cause the computing system to perform actions comprising:
receiving input regarding a production fill of an alcoholic blended beverage for a high-speed filling machine including a selected alcoholic blended beverage having a required syrup/water ratio, a selected target alcohol strength (“% ABV Target”), an alcohol strength of an alcohol supply (“% ABV Supply”), a type of container, and a selected container filling rate;
calculating a required volumetric mass flow of alcoholic blended beverage ingredients for the production fill;
calculating, with a computing system, a required alcohol volumetric mass flow of the alcohol supply for the production fill;
calculating, with a computing system, a required blended syrup and water volumetric mass flow of a proportioner for the production fill;
calculating, with a computing system, a required syrup volumetric mass flow of a syrup supply to the proportioner for the production fill;
calculating, with a computing system, a volumetric mass flow of water in the required alcohol volumetric mass flow of the alcohol supply;
calculating, with a computing system, a required water volumetric mass flow of a water supply to the proportioner for the production fill accounting for the calculated volumetric mass flow of water in the required alcohol volumetric mass flow of the alcohol supply; and
outputting instructions to a continuous blend system associated with the high-speed filling machine for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow into the continuous blend system for supply of the alcoholic blended beverage to the high-speed filling machine.

10. A continuous blend system for a high-speed filler configured to continuously blend alcohol, water, and syrup to produce an alcoholic blended beverage having a having a selected syrup/water ratio and a selected target alcohol strength (“% ABV Target”), the continuous blend system comprising:
a mass flow based multi-stream blending assembly, comprising:
an alcohol supply for supplying a required volumetric mass flow of alcohol having an alcohol supply strength (“% ABV Supply”);
a proportioner for supplying a required volumetric mass flow of blended syrup and water;
a water supply in selective fluid communication with the proportioner for supplying a required volumetric mass flow of water to the proportioner;
a syrup supply in selective fluid communication with the proportioner for supplying a required volumetric mass flow of syrup to the proportioner; and
a computing system having non-transitory computer-readable storage medium with instructions stored thereon that, in response to execution by one or more processors of the computing system, cause the computing system to perform actions comprising:
receiving input regarding a production fill of an alcoholic blended beverage for a high-speed filling machine including a selected alcoholic blended beverage having a required syrup/water ratio, a selected target alcohol strength (“% ABV Target”), the alcohol supply strength (“% ABV Supply”), a type of container, and a selected container filling rate;
calculating a required volumetric mass flow of alcoholic blended beverage ingredients for the production fill;
calculating a required alcohol volumetric mass flow of the alcohol supply for the production fill;
calculating a required blended syrup and water volumetric mass flow of a proportioner for the production fill;
calculating a required syrup volumetric mass flow of a syrup supply to the proportioner for the production fill;
calculating a volumetric mass flow of water in the required alcohol volumetric mass flow of the alcohol supply;
calculating a required water volumetric mass flow of a water supply to the proportioner for the production fill accounting for the calculated volumetric mass flow of water in the required alcohol volumetric mass flow of the alcohol supply; and
outputting instructions for activating actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow to the tank for supply of the alcoholic blended beverage to a high-speed filling machine.

11. The continuous blend system of claim 10, wherein the required volumetric mass flow of alcoholic blended beverage ingredients for the production fill is the required volumetric mass flow of alcoholic blended beverage ingredients for supply to the filler for filling a required number of the selected type of containers for the selected container filling rate.

12. The continuous blend system of claim 10, wherein the required alcohol volumetric mass flow for the production fill is calculated by the following equation:
REQUIRED ALCOHOL VOLUMETRIC MASS FLOW=(REQUIRED VOLUMETRIC MASS FLOW OF ALCOHOLIC BLENDED BEVERAGE INGREDIENTS/%ABV SUPPLY)*%ABV TARGET).

13. The continuous blend system of claim 10, wherein the required blended syrup and water volumetric mass flow for the production fill is calculated with the following equation:
REQUIRED BLENDED SYRUP AND WATER VOLUMETRIC MASS FLOW=REQUIRED VOLUMETRIC MASS FLOW OF ALCOHOLIC BLENDED BEVERAGE INGREDIENTS−REQUIRED ALCOHOL VOLUMETRIC MASS FLOW.

14. The continuous blend system of claim 10, wherein the required syrup volumetric mass flow is calculated with the following equation:
REQUIRED SYRUP VOLUMETRIC MASS FLOW=((REQUIRED BLENDED SYRUP AND WATER VOLUMETRIC MASS FLOW/(SYRUP/WATER RATIO)))+SYRUP DENSITY.

15. The continuous blend system of claim 10, wherein the volumetric mass flow of water in the alcohol supply is calculated with the following equation:
VOLUMETRIC MASS FLOW OF WATER IN ALCOHOL SUPPLY=REQUIRED ALCOHOL VOLUMETRIC MASS FLOW*% WATER IN THE ALCOHOL SUPPLY.

16. The continuous blend system of claim 15, wherein the % of water in the alcohol supply is the % ABV Supply subtracted from 100.

17. The continuous blend system of claim 10, wherein the required water volumetric mass flow is calculated with the following equation:
REQUIRED WATER VOLUMETRIC MASS FLOW=(REQUIRED BLENDED SYRUP AND WATER VOLUMETRIC MASS FLOW−REQUIRED SYRUP VOLUMETRIC MASS FLOW)−VOLUMETRIC MASS FLOW OF WATER IN THE ALCOHOL SUPPLY.

18. The continuous blend system of claim 10, further comprising Coriolis mass flow meters associated with each of the alcohol supply, the syrup supply, the water supply, and the proportioner for taking a mass flow reading of each of the alcohol flowing from the alcohol supply, the syrup flowing from the syrup supply, the water flowing from the water supply, and the blended syrup and water flowing from the proportioner.

19. The continuous blend system of claim 18, wherein the Coriolis mass flow meters are configured to output one or more signals indicative of a mass flow rate of the alcohol flowing from the alcohol supply, the syrup flowing from the syrup supply, the water flowing from the water supply, and the blended syrup and water flowing from the proportioner to the computing system.

20. The continuous blend system of claim 18, wherein the non-transitory computer-readable storage medium of the computing system has instructions stored thereon that, in response to execution by the one or more processors of the computing system, cause the computing system to output instructions for activating the actuators associated with valves of the alcohol supply, the syrup supply, the water supply, and the proportioner to introduce the corresponding required alcohol volumetric mass flow, the required syrup volumetric mass flow, the required water volumetric water flow, and the required blended syrup and water volumetric mass flow to the tank for supply of the alcoholic blended beverage to a high-speed filling machine.

21-25. (canceled)
